(19) United States
(12) Patent Application Publication
(10) Pub. No.: US 2004/0258415 A1
(43) Pub. Date: Dec. 23, 2004

(54) Techniques for secure free space laser communications

(76) Inventors: Bradley G. Boone, Columbia, MD (US); Donald D. Duncan, Silver Spring, MD (US); Raymond M. Sova, Owings Mills, MD (US)

Correspondence Address: The Johns Hopkins University, Office of Patent Counsel, Applied Physics Laboratory, 11100 Johns Hopkins Road, Laurel, MD, 20723-6099, US

(21) Appl. No.: 10/860,370

(22) Filed: Jun. 3, 2004

Related U.S. Application Data
(60) Provisional application No. 60/479,274, filed on Jun. 18, 2003.

(51) Int. Cl. G03H 1/00

(52) U.S. Cl. 398/125

(57) ABSTRACT

Techniques for establishing a free-space optical communications link between a local terminal and a remote terminal include determining that a remote terminal is within a wide field of view associated with a micromechanical mirror in a local terminal. The risk of an undesirable effect which imposes a performance or security problem is also determined to occur within the wide field of view. The micromechanical mirror is pointed by including the remote terminal within a narrow field of view that is narrower than the wide field of view, and by reducing the risk that the undesirable effect is within the narrow field of view.

### CROSS-REFERENCE TO RELATED APPLICATIONS

This application claims benefit of U.S. Provisional Application. 60/479,274, filed Jun. 18, 2003, the entire contents of which are hereby incorporated by reference as if fully set forth herein, under 35 U.S.C. §119(e).

### BACKGROUND OF THE INVENTION

1. Field of the Invention

The present invention relates to free-space optical communications; and, in particular, to techniques for aiming laser beams to improve security in free-space laser communications.

2. Description of the Related Art

Free-space laser communications systems have been proposed for mobile communications in sparsely populated areas and in military applications, among others. For example, see United States Patent Application Publication US2004/0001720, by J. A. Krill, D. D. Duncan, C. R. Moore, J. Cipriano, and R. M. Sova, entitled “Satellite-based mobile communication system” (hereinafter Krill), the entire contents of which are hereby incorporated by reference as if fully set forth herein.

Free-space laser communications occur in a narrow laser beam over direct lines of sight between a receiver and a transmitter. A device that both receives and transmits for communication is called a transceiver. In the following, the term transceiver is used to refer to an optical transceiver, such as a laser transceiver, unless otherwise indicated explicitly or by context. In the following, a device involved in optical communications is called a terminal, whether the device is a receiver, a transmitter, or a transceiver. In an example system, a local terminal identifies one or more remote terminals in a portion of space called a field of regard over which line of sight communications are possible, or both possible and desirable. Often a field of view of the local terminal is more limited than the field of regard. The field of view of the local terminal is then directed to encompass at least one of the remote terminals. Tracking systems are used to keep the remote terminal in the field of view of the local terminal as either or both terminals move.

Among the challenges in establishing networks of optical free-space communications links is pointing accuracy. The free space paths are quite long in some scenarios, e.g., from ground or aircraft to satellite, so small pointing errors can cause a beam to entirely miss an intended terminal. One or both terminals for a link may be moving. When the moving terminals are close to each other, the angular rate of change may be sufficient to prevent gimbaled pointing mechanisms with large mass and moments of inertia from keeping an optical link open. The problem is especially difficult with aircraft moving in different directions with large accelerations. Such accelerations may occur in military scenarios, with small unmanned aircraft, or in emergency situations when communications are even more important.

One or more millimeter-scale mirrors on a micro-electromechanical system (MEMS) device can direct a transmitted beam or a received beam in a terminal. MEMS devices, well known in the art, are fabricated at small scales using integrated circuit fabrication techniques. Such fabrication techniques are undergoing continual improvement to reach smaller scale MEMS devices with higher precision and reliability. Very low per-unit costs can be achieved when MEMS devices are produced in very large quantities. Mirrors of millimeter scale or smaller on a MEMS device are hereinafter called micromechanical mirrors. Micromechanical mirrors have small size, low-mass and consume small amounts of electrostatic energy to steer, thus they promise relatively rapid tracking and small size suitable for optical terminals on unmanned mobile platform and aircraft, including satellites.

Another challenge is security. Because the optical links are in free-space, they are subject to interference and interception by entities that are not under the control of the parties trying to communicate over the link. Network integrity and the network's quality of service (QOS) contracts may be compromised by non-malicious interference, such as caused by aircraft and atmospheric phenomena, or by malicious interference by mischievous or hostile entities. Hostile entities may try to intercept optical signals transmitted over the links to extract the information thereon, jam the links by sending high energy signals that swamp legitimate signals, spoof communications by sending data that appears valid but is actually misleading or damaging, or perform other attacks. To protect against some of these attacks, authentication procedures have been developed to help distinguish legitimate terminals from illegitimate terminals. Authentication alone, however, does not prevent jamming and interception attacks.

Optical beam communications, such as laser communications, are less subject to attack if multiple optical links are formed simultaneously with multiple remote terminals in a network configuration. Then a successful attack on one link may be mitigated by a successful communication over a different link.

Micromechanical mirrors can be fabricated in large numbers in arrays of one or two dimensions and can be independently steered. Such arrays can be used to keep multiple optical links open with multiple remote terminals to circumvent attacks on individual optical links.

According to Krill, multichannel laser communications are achieved in banks of laser transceivers. These banks of laser transceivers use arrays of laser sources and optical detectors with other optical components such as optical amplifiers. For example, of multiple coupled optical signals emanating from a laser amplifier bank, each coupled optical signal has associated with it a separate mirror located in a bank of micromechanical mirrors. A beam steering controller separately controls each mirror to steer the optical signal to a remote transceiver. In some embodiments, Krill uses optical switches instead of micromechanical mirrors because of perceived drawbacks in the time it takes from issuing an electrical command to the end of the mechanical adjustment commanded. Krill gives few details on the makeup and control of the micromechanical mirrors for use in beam steering, and does not suggest using the micromechanical mirrors for improving security of the optical communications links.

Based on the foregoing, there is a clear need for techniques for free-space optical communications that do not suffer the disadvantages of the prior art. In particular, there is a need for techniques to form free-space optical links that use micromechanical mirrors for their small size and low mass and yet can be more accurately pointed and less subject to security risks than prior art approaches.

The past approaches described in this section could be pursued, but are not necessarily approaches that have been previously conceived or pursued. Therefore, unless otherwise indicated herein, the approaches described in this section are not to be considered prior art to the claims in this application merely due to the presence of these approaches in this background section.

### SUMMARY OF THE INVENTION

Techniques are provided for establishing a free-space optical communications link between a local terminal and a remote terminal. In one set of embodiments, a method includes determining that a remote terminal is within a wide field of view associated with a micromechanical mirror in a local terminal. The risk of an undesirable effect which imposes a performance or security problem is also determined to occur within the wide field of view. The micromechanical mirror is pointed by including the remote terminal within a narrow field of view that is narrower than the wide field of view, and by reducing the risk that the undesirable effect is within the narrow field of view.

In some of these embodiments, the narrow field of view is formed using a telephoto lens between the mirror and the remote terminal. In some embodiments, the narrow field of view is an instantaneous field of view that is viewed by the micromechanical mirror at one instant, and the wide field of view is made up of multiple instantaneous fields of view associated with corresponding pointing directions of the micromechanical mirror at corresponding different times.

In another set of embodiments, a local terminal implements means to accomplish these functions. In yet another set of embodiments, a computer readable medium stores a set of instructions that cause a processor to accomplish these functions.

In one set of embodiments, a local terminal for a free-space optical communications link with a remote terminal includes an optical communication terminal, a micromechanical mirror, an optical coupler, a controller, and one or more processors. The optical coupler couples the optical communications terminal with the micromechanical mirror to produce a particular size field of view. The controller points the micromechanical mirror within a range of angles, e.g., based on instructions received by the controller. The processors are operatively connected to the controller. The processors determine a remote terminal within a wide field of view. The wide field of view is based on the particular size field of view. The processors also determine that there is a risk of an undesirable effect which imposes a security or performance cost within the wide field of view. The processor sends an operating signal to the controller that causes the controller to point the micromechanical mirror to include the remote terminal within a narrow field of view and to reduce the risk of the undesirable effect occurring within the narrow field of view. The narrow field of view is also based on the particular size field of view, and is narrower than the wide field of view.

In some of these embodiments, a telephoto lens disposed in an optical path between the micromechanical mirror and the remote terminal reduces the particular size field of view to the narrow field of view, e.g., by the magnification factor of the lens.

In some of these embodiments the local terminal includes a tracking array of optical detectors, and the optical coupler includes a beam splitter. The beam splitter directs a portion of optical energy of optical signals received from the remote terminal to the tracking array to indicate where the remote terminal is currently or where it is moving or both. This information may be used to position the narrow field of view.

In some of these embodiments, the local terminal includes multiple optical communication terminals, a corresponding number of micromechanical mirrors on an integrated unit, and a corresponding number of optical couplers.

In one set of embodiments, a local terminal for a free-space optical communications link with a remote terminal includes an optical communication terminal, a micromechanical mirror, a first optical coupler, a controller, a photo-detector array, a second optical coupler, and a processor. The optical communications terminal includes at least one of an optical communications transmitter and an optical communications receiver. The first optical coupler couples the optical communications terminal with the micromechanical mirror to produce a particular size field of view in free space. The controller steers the micromechanical mirror within a range of angles. The second optical coupler couples at least part of a received optical beam to the photo-detector array. The one or more processors are operatively connected to the controller and the photo-detector array. The processors track a remote optical source position associated with the field of view of the micromechanical mirror based on measurements obtained by the photo-detector array, and sends an operating signal to the controller. The operating signal causes the controller to point the micromechanical mirror based at least in part on the tracked position of the remote optical source.

These techniques can be used to provide improved security against such optical link problems as noise, interference, interception, jamming, and spoofing, among others, by directing a narrow field of view away from an undesirable effect, such as a terminal that is not authenticated. These techniques can be used to provide improved security just by directing a narrow field of view toward an authenticated terminal, even without knowledge of the position of the undesirable terminal. These techniques can also be used to provide improved performance. By directing a narrow field of view toward an authenticated terminal, for example, the amount of background noise competing with the authenticated terminal is reduced.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a free-space optical communications network;

FIG. 2 is a block diagram that illustrates one free-space optical communications terminal with a free-space field of view, according to an embodiment;

FIG. 3A is a block diagram that illustrates the positions of various sources within a wide field of view in angle space, according to an embodiment;

FIG. 3B is a block diagram that illustrates the positions of various sources and a narrow field of view within the wide field of view of FIG. 3A, according to an embodiment;

FIG. 4 is a flow diagram that illustrates a method for using micromechanical mirrors to steer optical beams for optical links, according to an embodiment;

FIG. 5A is a block diagram that illustrates an apparatus for independently steering multiple optical links with micro-mechanical mirrors, according to an embodiment;

FIG. 5B is a block diagram that illustrates an apparatus for independently steering multiple optical links with micro-mechanical mirrors, according to a more detailed embodiment;

FIG. 6 is a block diagram that illustrates the use of a photo-detector array for tracking sources within fields of view, according to an embodiment; and

FIG. 7 is a block diagram that illustrates a computer system upon which an embodiment of the invention may be implemented.

### DETAILED DESCRIPTION

A method and apparatus are described for free-space optical communications. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

One or more embodiments of the invention are described in the context of laser beam communications among networks of mobile laser communication terminals, including one or more unmanned aircraft (including satellites and unmanned airborne vehicles, UAVs), as well as personal communications terminals and land vehicle communications terminals. In this context, successful optical communications involves several functions that are performed approximately in the following sequence: pointing, acquisition, tracking, stabilization, communication, and authentication. However, the invention is not limited to this context. For example, the invention may be practiced with one, more or all fixed terminals, and with multiple links in addition to one or more optical free-space links, among other embodiments.

1. Operation Overview

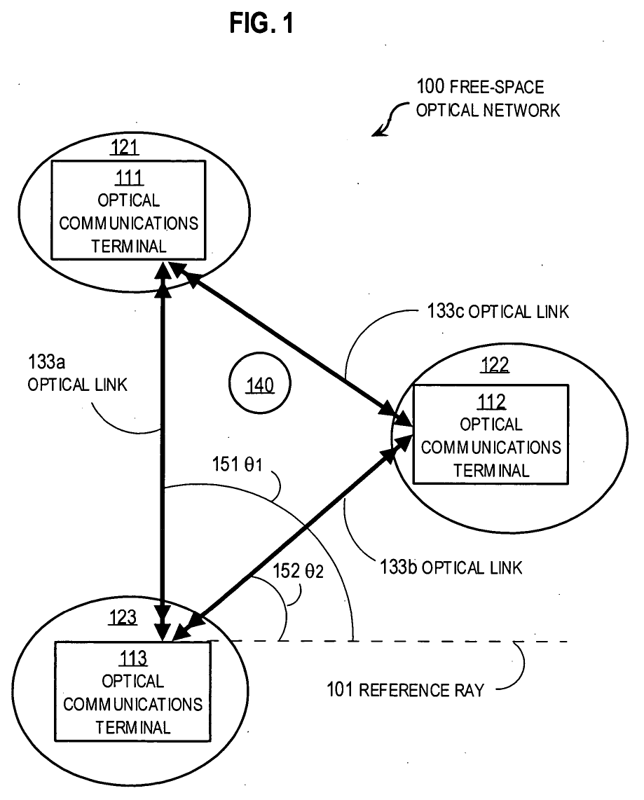

FIG. 1 is a block diagram that illustrates a free-space optical communications network. The illustrated network includes three multi-channel optical communications terminals 111, 112, 113 on three platforms 121, 122, 123, respectively. The multi-channel optical communications terminals 111, 112, 113 are separated by free space, i.e., they are not linked to each other by cables. In other networks, more or fewer terminals on corresponding platforms are included. A platform is any entity that supports or moves an optical communications terminal, such as a tower, a person, a manned or unmanned vehicle, and a manned or unmanned aircraft, such as a satellite, among others.

Each terminal is in communication with other terminals in the network by one or more free-space optical links. For example, in the illustrated embodiment, the terminal 113 communicates with the network 100 through free-space optical link 133a to terminal 111 and free-space optical link 133b to terminal 112. The free-space optical path is depicted with a thick arrow with a double arrowhead pointing in the direction from source to receiver. A free-space optical link between two transceivers is depicted with a double arrowhead in both directions, and is capable of full duplex communications. In the illustrated embodiment, the free-space optical links 133a, 133b from terminal 113 are both duplex optical links between two transceivers. Similarly, transceiver 111 communicates with transceiver 112 of the network 100 through duplex free-space optical link 133c.

The positions of remote terminals with respect to a local terminal may be expressed as an angle relative to a reference ray in a reference plane emanating from the local terminal. For example, in FIG. 1, taking terminal 113 as the local terminal, the remote terminal 111 is at an angle θ1 (represented by arc 151 from reference ray 101). Similarly, the remote terminal 112 is at an angle θ2 (represented by arc 152 from reference ray 101).

Also shown in FIG. 1 is an undesirable object 140, such as a passing aircraft or atmospheric feature that may block or reduce signal strength on an optical link. In some embodiments, undesirable object 140 is a noise source. In some embodiments, undesirable object is a hostile vehicle intent on intercepting secure communications, or jamming the signals on legitimate optical links with one or more spurious optical signals. In some embodiments, more or fewer undesirable objects occupy the free space separating two or more optical communications terminals.

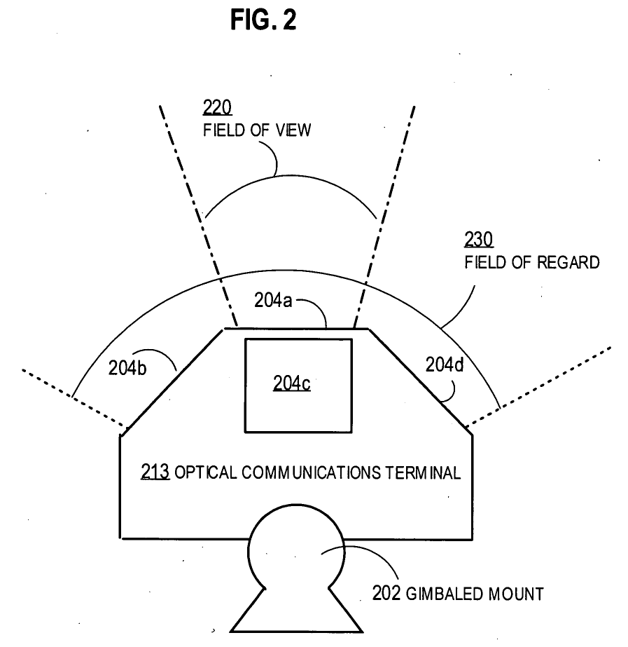

FIG. 2 is a block diagram that illustrates one free-space optical communications terminal 213 with a free-space field of view, according to an embodiment. In the illustrated embodiment, the optical communications terminal includes a gimbaled mount 202 which allows the optical communications terminal 213 to be rotated so as to provide aiming within the upper hemisphere. One or more optical paths through which optical beams can be passed (e.g., received, transmitted, or both) at the optical communications terminal 213 form a field of view 220. An optically active portion 204a of communications terminal 213 is responsible for the field of view 220. Any optically active component or components may be used to form the optically active portion 204a. For example, laser diodes, photo diodes, filters and optical couplers, such as optical fibers, collimators, circulators, gratings, filters, lenses and mirrors, among others, may be used. A local terminal, such as terminal 213, can communicate with a remote terminal that is within the field of view 220 of the local terminal.

In the illustrated embodiment, the optical communications terminal 213 may be moved on its gimbaled mount 202 to rotate the field of view 202 over a range of angles to define a field of regard 230. A field of regard is a range in angle space through which optical communications are possible and desirable, but which is not within the field of view of one optically active portion at one time. In some embodiments, the field of regard 230 is defined by multiple optically active portions, 204a, 204b, 204c, 204d oriented in different directions with corresponding different fields of view in different directions. In some embodiments, both a gimbaled mount and multiple optically active portions are employed.

2. Functional Overview

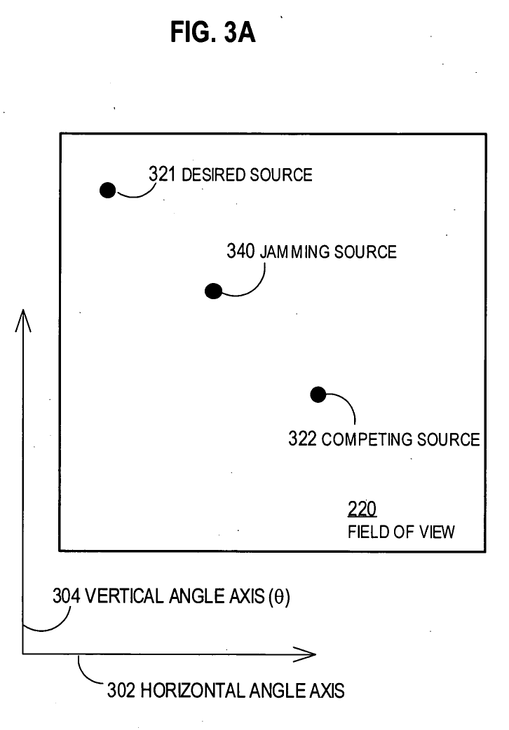

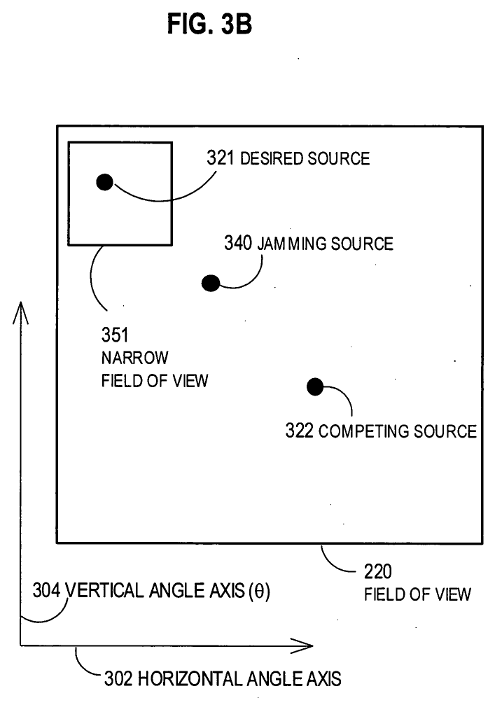

FIG. 3A is a block diagram that illustrates the positions of various sources within a wide field of view 220 in angle space, according to an embodiment. The angle space is defined by a horizontal angle axis 302 and a vertical angle axis 304, such as angle θ in FIG. 1. For purposes of illustration, it is assumed that the field of view is a portion of free-space visible in a square mirror when the mirror is viewed from a particular direction, such as the direction of an optical element like a laser or photo-diode detector. The center of the field of view represents the direction of specular reflection from the particular direction, and depends on how the mirror is tilted. The other positions in the field of view represent angles with small angular deviations from the direction of specular reflection. The total angle range in the field of view 220 depends on the size of the mirror and the distance to the optical element. Using smaller micromechanical mirrors gives a smaller field of view than using mechanical mirrors or larger micromechanical mirrors. Smaller fields of view can also be achieved by focusing optical elements on a smaller portion of the available mirror area

It is assumed in the following, for simplifying the description, that optical signals are received at the local terminal from several remote transmitters (also called “sources” herein). For example, a source may be a beacon, which is a terminal that includes brighter (usually pulsed) laser waveforms to facilitate initial detection and acquisition. It should be clear that similar features occur when the local terminal is transmitting to remote receivers. It is further assumed for purposes of illustration that all light of a particular wavelength range in the field of view 220 of the mirror impinges on a single photo-detector. In some embodiments, only a portion of the light of a particular wavelength range in the field of view 220, such as a circular or elliptical portion, impinges on the photo-detector.

Visible in the field of view 220 of the mirror are multiple sources 321, 322, 340 of optical signals to which the photo-detector is sensitive. Source 321 is a desired source for communications purposes, e.g., it is an earth-orbit satellite terminal for the network. Source 322 is a competing source for communications purposes, e.g. it is a more distant earth-orbit satellite terminal for the network (such as remote terminal 113 in FIG. 1) or an atmospheric refraction (sometimes called a “multipath” arrival) of signals from the desired source 321. Source 340 is a hostile source (such as terminal 140 in FIG. 1) that is sending jamming signals to overwhelm the photo-detector in the local terminal.

Because the photo-detector receives all optical energy in the wavelength range that impinges on the mirror, the signals from all the sources are combined at the photo-detector to form a composite signal. A signal processor at the local terminal then uses signal processing techniques to attempt to disassemble the composite signal into separate signals, and select the signal from the desired source 321. For example, the signals are cross-correlated with an authentication signal to select the signal from the desired source 321. Such signal processing may consume considerable computational resources at the local terminal and only imperfectly retrieve the signal from the desired source 321. For example, if a signal from the jamming source 340 is especially effective, it may be impossible for signal processing to separate the signal from the desired source in sufficiently short time to maintain communication, if at all.

FIG. 3B is a block diagram that illustrates the positions of various sources and a narrow field of view 351 within the wide field of view 220 of FIG. 3A, according to an embodiment. The narrow field of view 351 can be produced in any method known in the art. For example, smaller mirrors can be used or the distance from the optical element to the mirror can be increased. As another example, the optical path from the mirror to free space can be passed through a telephoto lens to reduce the field of view by the magnification factor of the lens. As another example, the laser or photo-detector using the mirror can be focused on a smaller portion of the mirror.

As can be seen, the narrow field of view 351 is pointed to include the desired source 321 and exclude both the jamming source 340 and the competing source 322. Without pointing the narrow field of view to include the desired source and exclude the jamming source, the narrow field of view would be at the center of the wider field of view 220. At the center of the wide field of view 220, a narrow field of view would not include the desired source 321 in the illustrated example. The optical link would be broken. In some situations, the narrow field of view might include the jamming source only and consume resources trying to process a signal that does not include any legitimate signals.

When the narrow field of view is pointed to the desired source and away from the jamming source 340 and competing source 322, only signals from the desired source 321 are received at the photo-detector. Signal processing to separate the signals can be simplified or eliminated.

The resulting free space optical communication link is more secure. In the illustrated example, the narrow field of view 351 is less susceptible to jamming. The narrow field of view is also less susceptible to a spoofing source than is the wide field of view 220. The narrow field of view 351 is also less susceptible to interception by a hostile remote terminal that is within the wide field of view 220. Even if the position of a hostile terminal is not known, using the narrow field of view 351 reduces the risk that a hostile terminal is within the narrow field of view.

The resulting free space optical communication link may also experience better performance. For example, during reception, if there is background noise, e.g., scattered light in the wavelengths of interest, the background area is reduced in the narrow field of view. The signal is not reduced but lies entirely within the narrow field of view. Therefore, the signal to noise ratio of the received signal is increased. During transmission, the transmitted beam is dispersed over the field of view. The transmitted beam is dispersed less in the narrower field of view 351 than in the wide field of view 220. Therefore the transmitted beam remains strong for a greater distance, thereby improving performance of the optical link. In some embodiments cross talk from multiple optical channels established on adjacent lasers, photodiodes and mirrors is reduced by using the narrow field of view instead of the wide field of view. In some embodiments cross-talk is reduced instead or in addition by using collimated transmitted laser beams and appropriately situated optical stops.

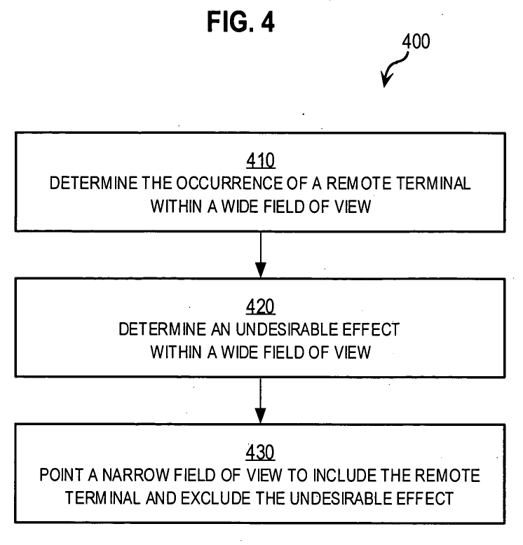

FIG. 4 is a flow diagram that illustrates a method 400 for using micromechanical mirrors to steer optical beams for optical links, according to an embodiment. Although steps are shown in FIG. 4 in a particular order for the purposes of illustration, in other embodiments the steps may be performed in a different order or overlap in time. For example, steps 410 and 420 may be performed in reverse order or overlapping in time.

In step 410, it is determined whether there is a desired remote terminal within a wide field of view. Any method may be used to establish the wide field of view. For example, a wide mirror close to a photo-detector or laser is used in some embodiments. In some embodiments, a micromechanical mirror is used without a telephoto lens. In some embodiments, a micromechanical mirror can be scanned across a range of pointing angles in one or more dimensions to sweep out the wide field of view. In some embodiments, a narrow field of view formed by passing the field of view of the micromechanical mirror through a telephoto lens is scanned across a range of pointing angles in one or more dimensions to sweep out the wide field of view.

Step 410 includes determining whether there is a desirable terminal within the wide field of view. Any method may be used to determine whether there is a desirable terminal in the wide field of view. In some embodiments, the occurrence of the desired terminal is determined from outside information that indicates a relative position of the desired terminal from the local terminal. For example, global positioning system (GPS) data is used to determine the position of a remote terminal (such as the position of an earth-orbit satellite carrying the remote terminal) or the local terminal or both. The position of the remote terminal is broadcast by radio or sent over an existing optical link to the local terminal or both. The local processor determines the orientation of the local terminal and the look direction to view the position of the remote terminal.

In some embodiments, a radio message is sent or broadcast that indicates the position of the remote terminal or a relative look angle to be used at the local terminal for placing the remote terminal in the center of a wide field of view. In some embodiments, the local terminal looks within the wide field of view to determine whether a properly authenticated signal has been received. In some embodiments, the wide field of view is rotated using the gimbaled mount through a field of regard until an authenticated signal is received within the wide field of view.

In step 420, the local terminal determines whether there is or may be an undesirable effect in the field of view. In some embodiments, a processor at the local terminal determines that an actual undesired terminal is within the wide field of view. For example, an operator at the local terminal observes a hostile aircraft in the vicinity. In some embodiments, the local terminal receives an optical signal that cannot be authenticated from a particular source in the wide field of view and determines that the optical signal is from an undesired source.

In some embodiments, during step 420, the processor determines a risk that an undesirable effect is in the field of view. For example, the processor determines from data received over existing optical links or from radio communications that a hostile aircraft was observed flying into the vicinity of the local terminal at a given bearing and speed. The processor then computes the probability of the hostile aircraft occupying each pointing position within the wide field of view. The probability is a measure of the risk that an undesired terminal is in the wide field of view.

In some embodiments, step 420 includes determining the background noise, e.g., the amount of optical radiation in the wavelength band of sensitivity coming diffusely from many directions in the sky. If the background noise level is high enough, the wide field of view is abandoned for the narrow field of view in order to decrease the amount of noise in the field of view and thereby increase the signal to noise ratio. In some embodiments, step 420 includes determining the dispersion of a beam transmitted from the local terminal and the distance to the remote terminal. If the dispersion is high enough to reduce the signal strength at the remote terminal below a threshold level, the wide field of view is abandoned for the narrow field of view in order to decrease the amount of dispersion and thereby increase the signal to noise ratio at the remote terminal.

In step 430 a narrow field of view is pointed to include the desired remote terminal and to reduce the undesirable effect. For example, the narrow field of view is formed by passing the optical path with the wide field of view through a telephoto lens, and the mirror is pointed toward the most likely position of the desired terminal. In some embodiments, a scanning narrow field of view is fixed on an authenticated signal, such as the first authenticated signal found, or the last authenticated signal found, or the position of one of several authenticated signals found during scanning. Pointing the narrow field of view on a known position of the desired terminal decreases the risk of including one or more undesired terminals in the wide field of view, even when the positions of the undesired terminals are not known or are known to be widely scattered. If the positions of one or more undesired terminals are known, the pointing is also based on avoiding the undesired terminals.

In some embodiments, step 430 includes tracking the desired terminal to predict its rate of change to its next most likely position, and pointing the mirror toward the next most likely position computed from the tracker. Any tracking method known in the art may be used. In some embodiments, step 430 includes tracking one or more undesirable terminals to predict their rate of change to their next most likely positions, and pointing the mirror away from the next most likely position computed from the tracker for the undesired terminal. Any tracking method known in the art may be used.

In some embodiments, step 430 is omitted if it is determined that no security or performance problems are detected or expected from using the wide field of view.

3. Structural Overview

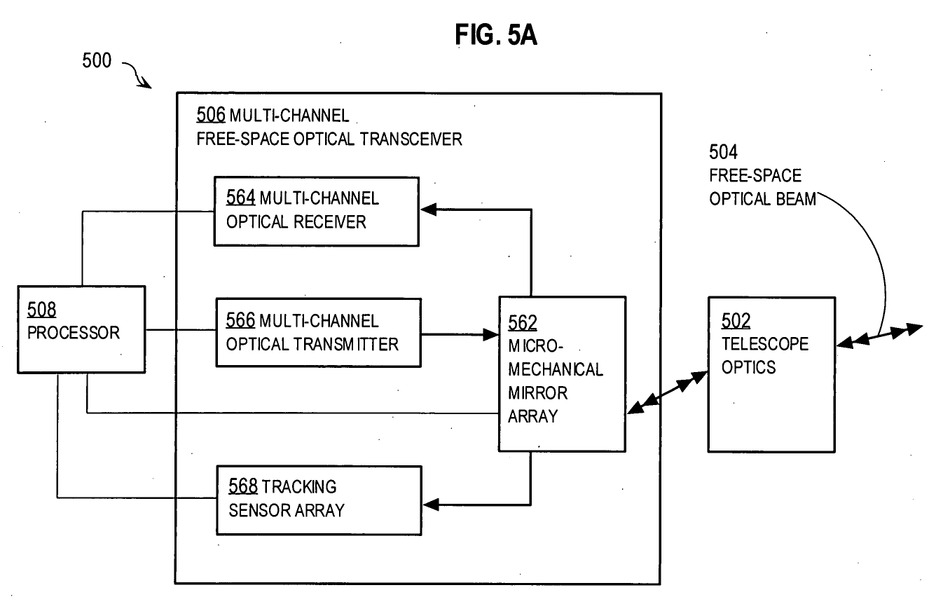

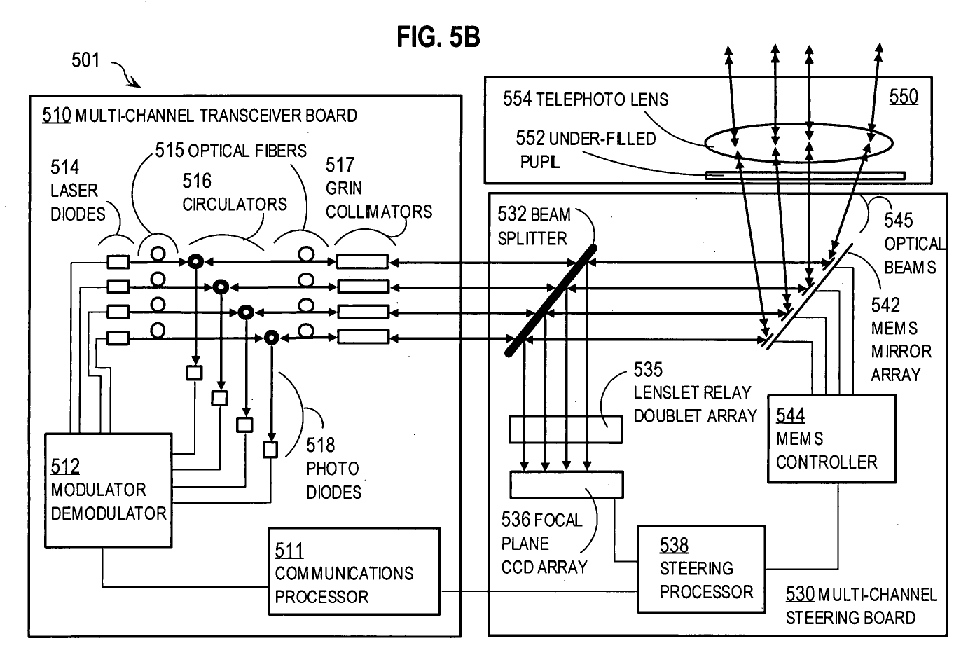

FIG. 5A is a block diagram that illustrates an apparatus 500 for independently steering optical links with micro-mechanical mirrors, according to an embodiment. Apparatus 500 may be used in a terminal for free-space optical communications and includes telescope optics 502, a multi-channel free-space optical transceiver 506 for free-space optical communications and a processor 508 for controlling components of the transceiver 506. In FIG. 5A, electrical connections are indicated by thin lines without arrowheads, optical paths are indicated by thick lines with arrowheads indicating the direction or directions of propagation. Free-space optical paths are indicated by double arrowheads, while optical paths in optical waveguides are indicated by single arrowheads.

In some embodiments the telescope optics 502 are omitted. In some embodiments, the functions performed by processor 508 are divided among one or more processors, some or all included in the multi-channel free-space optical transceiver 506 and some or all on an external processor. In various embodiments, the multi-channel free-space optical transceiver 506 is replaced by a multi-channel optical receiver or a multi-channel optical transmitter, or a single channel terminal.

The components of the illustrated multi-channel free-space optical transceiver 506 include a micromechanical mirror array 562, a multi-channel optical receiver 564, a multi-channel optical transmitter 566, and a tracking sensor array 568. One mirror in the micromechanical mirror array 562 is used for each channel. Information from the tracking sensor array 568 is passed to processor 508 and used to point mirrors in the micromechanical mirror array 562.

According to embodiments of the invention, the processor 508 points mirrors in array 562 to form a narrow field of view that includes a desired remote terminal. In some embodiments, the pointing is based on remote terminal tracking information based on output from the tracking sensor array 568. In some embodiments, the narrow field of view of a mirror in array 562 is formed by the telescope optics 502. When the mirror or mirrors in array 562 are pointed so that one or more free-space optical beams, such as free-space optical beam 504, forms an optical link with a remote terminal (not shown), optical signals on those optical links are transferred to receiver 562 or from transmitter 566 or both.

4. Example Embodiment

FIG. 5B is a block diagram that illustrates an apparatus 501 for independently steering multiple optical links with micro-mechanical mirrors, according to a more detailed embodiment. Apparatus 501 may be used in a terminal for free-space optical communications and includes a multi-channel transceiver board 510 for optical communication, a multi-channel steering board 530 for steering free-space optical beams, and telescopic optics 550. As in FIG. 5A, electrical connections are indicated by thin lines without arrowheads, optical paths are indicated by thick lines with arrowheads indicating the direction or directions of propagation. Free-space optical paths are indicated by double arrowheads, while optical paths in optical waveguides are indicated by single arrowheads. In the illustrated embodiment, four optical communications channels arranged along one dimension are illustrated; and each channel makes use of several optical components that are individually well known in the art. In other embodiments, more or fewer optical communications channels are used, arranged in one or more dimensions; and more or fewer optical components are used with each channel.

The multi-channel transceiver 510 includes a communications processor 511, a modulator/demodulator 512, and a bank of one or more laser diodes 514—one laser diode for each transmission optical channel. The multi-channel transceiver 510 also includes optical fibers 515, optical circulators 516, and gradient index of refraction (GRIN) collimators 517. In other embodiments, other components may be used. For example, any fiber optic compatible collimators can be used in place of or in addition to the GRINs. The multi-channel transceiver 510 also includes a bank of one or more photo-diodes 518.

The laser diodes 514 emit optical signals for an optical transmitter based on input electrical signals from the modulator circuits of the modulator/demodulator 512. For example, the optical signals are coded binary bits on an optical carrier with a particular wavelength. The input electrical signals are received from modulator circuits of modulator/demodulator 512 along electrical connections. In the illustrated embodiment, the optical signals emitted by the laser diodes 514 are transferred through optical fibers 515 and circulators 516 to the bank of GRIN collimators 517. The optical circulators 516 serve to split the optical signal between transmit and receive fibers coupling to their respective laser 514 and photo-diode 518. The GRIN collimators reduce spatial dispersion in the optical beam away from the direction of propagation. The GRIN collimators form parallel optical transmit beams for ease of coupling directly to their corresponding micro-mirrors while minimizing possible cross-talk. The optical beams emitted from the GRIN collimators are directed to the multi-channel steering board 530 for transmitting a free-space optical beam and establishing an optical link with a remote terminal. Each GRIN collimator establishes an optical path from the particular collimator to a particular micromechanical mirror in the multi-channel steering board 530.

Optical signals received from a remote terminal are passed into at least one of the GRIN collimators, in the opposite direction, e.g., from the multi-channel steering board 530. Each GRIN collimator receives optical signals from its particular micromechanical mirror in the multi-channel steering board 530. In particular, each GRIN collimator establishes an optical path from a particular micromechanical mirror in the multi-channel steering board to the collimator. The optical signals are any optical signals that carry information, for example, are coded binary bits on an optical carrier with a particular wavelength. The optical signals are transmitted through the optical fibers 515 and circulator 516 and directed onto a photo-diode in the bank of photo diodes 518. An output electrical signal based on the received optical signal is produced and sent along electrical connections to the demodulator circuits of the modulator/demodulator 512. The demodulated data (e.g., the coded bits) are sent to the communications processor 511 to process the data for communications purposes. For example, the communication processor performs authentication on the coded bits to determine that the signals have been received from a legitimate remote transmitter.

In other embodiments, other arrangements of these or other optical components are used in multi-channel transceiver board 510. For example, one laser diode is used to provide an optical carrier for multiple transmission channels, and the optical carrier is subsequently modulated using one or more optical components, such as electro-optical devices, known in the art. As another example, in some embodiments, circulators 516 are augmented or replaced by one or more beam splitters. In some embodiments, transmitted beams and received beams with the same remote terminal use different channels. In some embodiments for an optical receiver, laser diodes 512 and circulators 516 are omitted and modulator/demodulator 512 is replaced with a demodulator. In some embodiments for an optical transmitter, photo-diodes 518 and circulators 516 are omitted and modulator/demodulator 512 is replaced with a modulator.

Multi-channel steering board 530 includes a beam splitter 532 and an array of one or more micromechanical mirrors, such as MEMS mirror array 542. In the illustrated embodiment, there is one mirror in the MEMS mirror array 542 for each channel in the multi-channel apparatus 501. Each mirror in MEMS mirror array 542 is on an optical path established by one GRIN collimator 517 in the multi-channel transceiver board 510. The multi-channel steering board 530 also includes a MEMS controller 544, a steering processor 538 and components of a tracking sensor. The tracking sensor components include a lenslet relay doublet array 535 and a focal plane array (FPA) of optical detectors, such as a focal plane charge coupled device (CCD) array 536 or an imaging complementary metal oxide semiconductor (CMOS) array.

The beam width from a collimator, the distance from the collimator to a mirror in the MEMS array, and the characteristics of the mirror combine to establish a mirror field of view. For example, for a given sized mirror, the field of view can be changed by changing the portion of the mirror that intersects a beam width formed by the corresponding collimator.

Optical beams from GRIN collimators 517 pass through the beam splitter 532 to impinge on corresponding mirrors in the MEMS mirror array 542. The mirrors in the MEMS array are independently steered in one or more directions by electrical signals received from MEMS controller 544. For example, micromechanical mirrors in MEMS mirror array 542 are steered by changing a tip angle and a tilt angle. The tip and tilt angle determine the vertical and horizontal angular position of the specular reflection point in the middle of the mirror field of view. Currently available micromechanical mirrors have a steering range of about +/−24 degrees, and a pointing accuracy finer than about 0.03 degrees.

The angular magnification of any telephoto lens and the micro-mirror size and tip/tilt range establish the mirror angular steering range. Optical signals received within the mirrors' instantaneous fields of view are reflected from the mirrors into the optical paths between the mirrors and the collimators 517. Signals from outside the fields of view are blocked inside the apparatus 501, typically by or lenslet array vignetting. Thus the optical paths from mirrors to collimators are considered as waveguide optical paths and not free-space optical paths, even though there may be no optical fibers or other optical components in the path.

A portion of the optical energy of the optical signals that are reflected into the optical paths from the mirrors to the collimators 517 are also reflected by beam splitter 532. The optical signals reflected from beam splitter 532 are directed to the tracking sensor array. The optical signals reflected from beam splitter 532 are focused and separated by lenslet relay doublet array onto focal plane CCD array 536. The lenslet relay doublet array 535 also prevents optical energy outside a mirror's field of view from striking the focal plane CCD array 536. This prevents crosstalk from different channels striking the same element in the CCD array 536. In an illustrated embodiment, a separate two-dimensional CCD array segment is included in array 536 for each mirror in the MEMS mirror array 542, as described in more detail in a later section. The CCD array 536 produces electrical signals that indicate the position of each source within the mirrors' fields of view. By virtue of multiple CCD elements per mirror, the tracking sensor array, such as CCD array 536, obtains position information that is lacking at the photo-diode bank 518 in the multi-channel transceiver board, which has only one photo-diode per mirror. The matching portion of the focal plane array (FPA) and the imaging lenslet array effective focal length determine a corresponding FPA tracking receiver field of view. In some embodiments, the FPA field of view for each mirror is matched to the field of regard of that mirror, e.g., the CCD array 536 produces electrical signals that indicate the position of each source within the mirrors' fields of regard.

In other embodiments, other optically active components are used with or instead of the lenslet relay doublet array 535 and the focal plane CCD array 536. For example a CMOS focal plane array (FPA) is used instead of, or in addition to, the CCD array 536 as the FPA.

The steering processor 538 determines the position of one or more optical effects in the mirrors' fields of view. The steering processor 538 then sends electrical signals to the MEMS controller 544 based on the positions determined. The electrical signals sent to the MEMS controller 544 indicate that one or more mirrors of the MEMS mirror array 542 should be pointed in one or more corresponding directions to include one or more desired source in the mirrors' fields of view. The steering processor 538 is also connected to communications processor 511. Information regarding the authentication of one or more sources in the fields of view is exchanged between the steering processor 538 and the communications processor 511. Based on this information, the steering processor 538 determines to exclude one or more unauthenticated sources form the mirrors' fields of view.

In the illustrated embodiment, apparatus 501 includes telescopic optics 550. Telescopic optics 550 includes a telephoto lens 554 with an under-filled pupil 552. The telescopic lens 554 magnifies sources in the mirrors' field of view by diminishing the angular range of mirror steering and the mirror field of view. The mirror field of view is therefore different from the field of view in free space outside the telescope optics. To differentiate them, the field of view outside the telescope optics is herein called the “free-space field of view.” For example, a lens with a magnification factor of 100, reduces the angle and angular range by the same factor. Thus a mirror with a mirror field of view of one degree has a free-space field of view of 0.01 degree after passing through a telephoto lens with magnification factor 100. In such embodiments, the free-space field of view is much narrower than the mirror field of view. Both fields of view are associated with the same mirror.

Similarly, the effect of steering each mirror is changed. If a micromechanical mirror can be steered by +/−10 degrees, the steering range in free space is also reduced by the magnification factor of the telescopic lens, e.g., to +/−0.1 degree. The accuracy of the steering is also improved (to a limit set by tracking or actuator noise). A steering error of 0.1 degree becomes a free-space pointing error of only 0.001 degree, i.e., 1 millidegree.

Currently available micromechanical mirrors have mechanical angular ranges of +/−12 degrees, yielding a specular optical angle range of +/−24 degrees. With a telephoto lens having a magnification factor of 100 times, this supports a free-space field-of-regard (and matching FPA field of view) of approximately 0.5 degrees (or 8 mrad where 1 mrad=1 milliradian=10⁻³ radians).

The under-filled pupil 552 allows the same telephoto lens to be simultaneously used by several independently-steered mirrors in the MEMS mirror array 542.

When the remote terminal in the illustrated embodiment does not have an active (laser) transmitter, but instead, for example, uses a retro-reflective spatial light modulator in a transponder-type mode, tracking is based on the remote terminal or its platform having a corner reflector that reflects an incoming beam into the opposite direction for a wide range of incoming directions. A signal transmitted from the local transceiver is reflected back to the local transceiver and used to track the remote terminal.

In the illustrated embodiment, the free-space field of view is the narrow field of view used to reduce security and performance problems. The wide field of view, which is used to determine the existence of one or more desired remote terminals or undesired effects, is formed by scanning the free-space field of view over a range of tilt and tip angles of the mirror at different times. In such an embodiment, the wide field of view associated with a particular mirror corresponds to a field of regard of that particular mirror. In other embodiments, the wide field of view is determined by reducing the magnification factor of the telephoto lens, or removing the telephoto lens, and the narrow field of view is determined by increasing the magnification factor of the telephoto lens, or adding the telephoto lens.

5. Tracking Remote Optical Sources

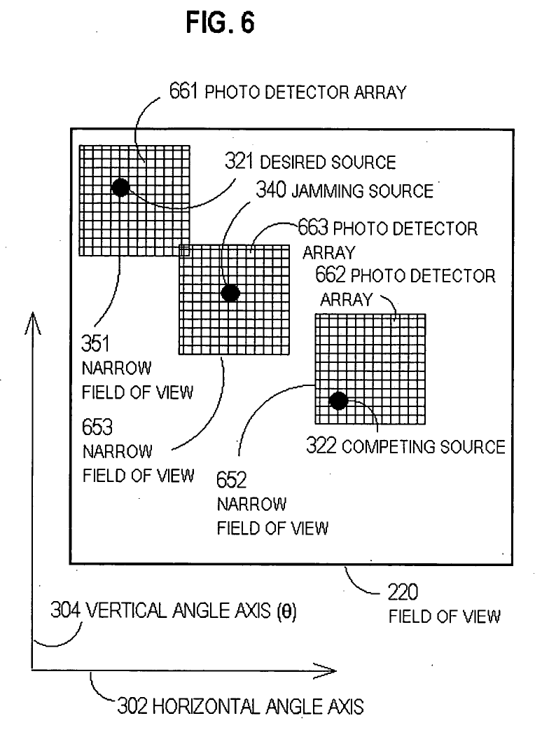

FIG. 6 is a block diagram that illustrates the use of a photo-detector array for tracking sources within fields of view, according to an embodiment. The narrow field of view 351 is the same as shown in FIG. 3B. In the illustrated example, the narrow field of view is formed by the instantaneous free-space field of view associated with one mirror at time t1, and the wide field of view is formed by scanning the instantaneous free-space field of view associated with the field of regard of that same mirror over a range of mirror tilt and tip angles at different times. For example at two different times t2 and t3, the instantaneous free-space field of view is given by narrow field of view 652 and narrow field of view 653, respectively.

Optical signals received in the instantaneous free-space field of view of a particular mirror of the MEMS mirror array are directed by beam splitter 532 onto a corresponding segment of a FPA (e.g., onto a segment of focal plane CCD array 536) dedicated to that particular mirror. In some embodiments, a photo detector in the segment of the FPA is a CCD, in some embodiments a photo-detector in the segment of the FPA is a CMOS. The photo detector array 661 in FIG. 6 is the segment of a FPA dedicated to the mirror associated with the wide field of view 220 and the narrow field of view 351. The segment is depicted as a grid of photo-detectors onto which the narrow field of view 351 is directed. An array of 15×15 photo-detectors is indicated in the segment for photo-detector array 661. In other embodiments, more or fewer photo-detectors are included in the segment of the FPA dedicated to each mirror.

The position of the desired source 321 is indicated by the dark circle to illustrate high intensity light in the particular wavelength used for communications. The photo-detectors in the segment that intersect the dark circle detect relatively high intensity light in the communications wavelength and are said to be illuminated by the source. The steering processor 538 uses the information about the illuminated detectors to compute the position of a centroid of illuminated detectors. The steering processor 538 uses the centroid of the illuminated photo-detectors and the tip and tilt of the associated mirror to determine the position of the source in angle space. Successive temporal determinations of the source position in angle space are used to track the location and relative motion of the source. Any method can be used to determine a track from subsequent centroid positions. For example, in some embodiments the proportional integral derivative (PID) control algorithm, well known in the tracking art, is used to track a source, such as the desired source 321.

As the centroid moves toward the edge of the narrow field of view 351 of a particular mirror, the mirror can be steered to move the specular point at the center of the mirror's narrow field of view toward the centroid of the illuminated detectors. As the centroid moves toward the edge of the wide field of view 220 of a particular mirror, information can be passed to steer another mirror in the MEMS mirror array, with an adjacent wide field of view, to the position in angle space where the centroid is predicted to pass into the adjacent wide field of view of the other mirror.

In some embodiments, sources of undesirable effects are also tracked. For example, the mirror is steered to scan a range of tip and tilt angles so that the narrow field of view is swept across the wide field of view. For some steering directions, the narrow field of view encompasses an undesirable source or effect. For example, at some tip and tilt angle, the narrow field of view 653 encompasses jamming source 340. The angular position of jamming source 340 is determined from the tilt-tip angle of the associated mirror and the centroid of the illuminated detectors depicted as photo detector array 663. This photo detector array is the same segment of the same FPA associated with this mirror in narrow field of view 351. That is, in this embodiment, photo detector array 663 is the same as photo detector array 661, but with the associated mirror steered to a different specular angle.

Similarly, the angular position of competing source 322 is determined from the tilt-tip angle of the associated mirror for narrow field of view 652 and the centroid of the illuminated detectors depicted as photo detector array 662.

In the illustrated embodiment, the narrow field of view associated with the mirror is then steered both to encompass the desired source 321 and to avoid as far as possible the jamming and competing sources 340, 322. For example, the associated mirror is steered to form a narrow field of view that is up and to the left of the narrow field of view 351 illustrated in FIG. 6. The steering may be limited by the field of regard or the wide field of view of the particular mirror.

In some embodiments, the distribution of background noise is also tracked as the narrow field of view is swept across the wide field of view. The mirror associated with the narrow field of view is steered to exclude the brightest sources of background noise in the angular vicinity of the desired source 321 while still encompassing the desired source 321.

6. Processor Hardware Overview

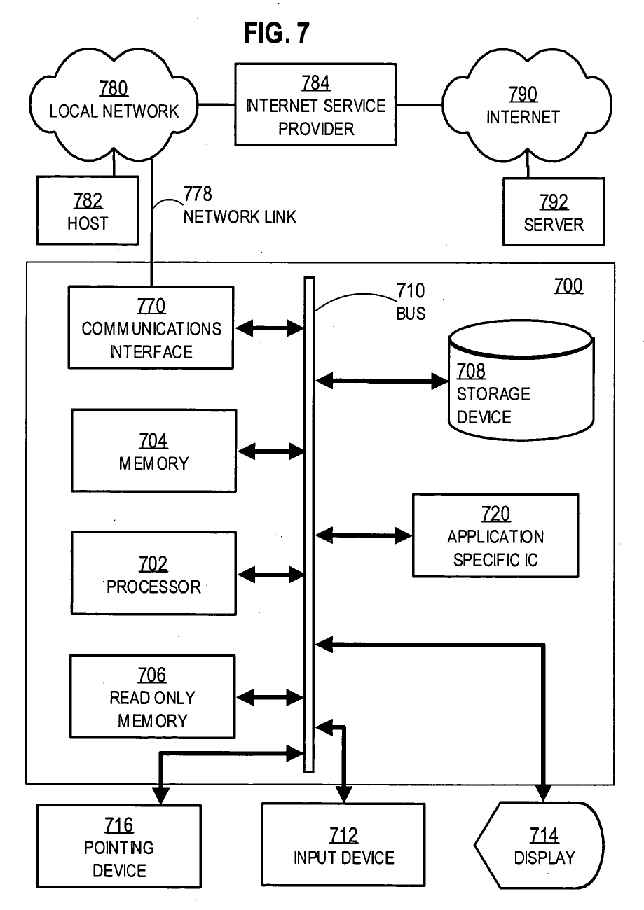

FIG. 7 is a block diagram that illustrates a computer system 700 upon which an embodiment of the invention may be implemented and which may serve as one or more processors in the disclosed embodiments. Computer system 700 includes a communication mechanism such as a bus 710 for passing information between other internal and external components of the computer system 700. Information is represented as physical signals of a measurable phenomenon, typically electric voltages, but including, in other embodiments, such phenomena as magnetic, electromagnetic, pressure, chemical, molecular and atomic interactions. For example, north and south magnetic fields, or a zero and non-zero electric voltage, represent two states (0, 1) of a binary digit (bit). A sequence of binary digits constitutes digital data that is used to represent a number or code for a character. A bus 710 includes many parallel conductors of information so that information is transferred quickly among devices coupled to the bus 710. One or more processors 702 for processing information are coupled with the bus 710. A processor 702 performs a set of operations on information. The set of operations include bringing information in from the bus 710 and placing information on the bus 710. The set of operations also typically include comparing two or more units of information, shifting positions of units of information, and combining two or more units of information, such as by addition or multiplication. A sequence of operations to be executed by the processor 702 constitute computer instructions.

Computer system 700 also includes a memory 704 coupled to bus 710. The memory 704, such as a random access memory (RAM) or other dynamic storage device, stores information including computer instructions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of computer instructions. The computer system 700 also includes a read only memory (ROM) 706 or other static storage device coupled to the bus 710 for storing static information, including instructions, that is not changed by the computer system 700. Also coupled to bus 710 is a non-volatile (persistent) storage device 708, such as a magnetic disk or optical disk, for storing information, including instructions, that persists even when the computer system 700 is turned off or otherwise loses power.

Information, including instructions, is provided to the bus 710 for use by the processor from an external input device 712, such as a keyboard containing alphanumeric keys operated by a human user, or a sensor. A sensor detects conditions in its vicinity and transforms those detections into signals compatible with the signals used to represent information in computer system 700. Other external devices coupled to bus 710, used primarily for interacting with humans, include a display device 714, such as a cathode ray tube (CRT) or a liquid crystal display (LCD), for presenting images, and a pointing device 716, such as a mouse or a trackball or cursor direction keys, for controlling a position of a small cursor image presented on the display 714 and issuing commands associated with graphical elements presented on the display 714.

In the illustrated embodiment, special purpose hardware, such as an application specific integrated circuit (IC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in special purpose hardware.

Computer system 700 also includes one or more instances of a communications interface 770 coupled to bus 710. Communication interface 770 provides a two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends and receives electrical, acoustic or electromagnetic signals, including infrared and optical signals, that carry information streams, such as digital data. Such signals are examples of carrier waves.

The term computer-readable medium is used herein to refer to any medium that participates in providing instructions to processor 702 for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 778 typically provides information communication through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server 792 connected to the Internet provides a service in response to information received over the Internet. For example, server 792 provides information representing video data for presentation at display 714.

The invention is related to the use of computer system 700 for implementing the techniques described herein. According to one embodiment of the invention, those techniques are performed by computer system 700 in response to processor 702 executing one or more sequences of one or more instructions contained in memory 704. Such instructions, also called software and program code, may be read into memory 704 from another computer-readable medium such as storage device 708. Execution of the sequences of instructions contained in memory 704 causes processor 702 to perform the method steps described herein. In alternative embodiments, hardware, such as application specific integrated circuit 720, may be used in place of or in combination with software to implement the invention. Thus, embodiments of the invention are not limited to any specific combination of hardware and software.

The signals transmitted over network link 778 and other networks through communications interface 770, which carry information to and from computer system 700, are exemplary forms of carrier waves. Computer system 700 can send and receive information, including program code, through the networks 780, 790 among others, through network link 778 and communications interface 770. In an example using the Internet 790, a server 792 transmits program code for a particular application, requested by a message sent from computer 700, through Internet 790, ISP equipment 784, local network 780 and communications interface 770. The received code may be executed by processor 702 as it is received, or may be stored in storage device 708 or other non-volatile storage for later execution, or both. In this manner, computer system 700 may obtain application program code in the form of a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to an infra-red signal, a carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for establishing a free-space optical communications link between a local terminal and a remote terminal, the method comprising the steps of:
determining, for a free-space optical communications link, a remote terminal within a wide field of view associated with a first micromechanical mirror in a local terminal;
determining, within the wide field of view, a risk of an undesirable effect which imposes at least one of a performance cost and a security cost; and
pointing the first micromechanical mirror by
including the remote terminal within a narrow field of view that is narrower than the wide field of view, and
reducing the risk of the undesirable effect being positioned within the narrow field of view.

2. The method as recited in claim 1, said step of pointing the first micromechanical mirror to include the remote terminal within the narrow field of view comprises including a telephoto lens in an optical path from the micromechanical mirror to the remote terminal.

3. The method as recited in claim 2, said step of including the telephoto lens in the optical path further comprising including the telephoto lens to decrease a size of the narrow field of view of the first micromechanical mirror compared to a size of an unmodified field of view of the micromechanical mirror without the telephoto lens in the optical path.

4. The method as recited in claim 1, wherein:
the narrow field of view is an instantaneous field of view that is viewed by the first micromechanical mirror at one instant; and
the wide field of view comprises a plurality of instantaneous fields of view associated with a corresponding plurality of pointing directions of the first micromechanical mirror at a corresponding plurality of instants.

5. The method as recited in claim 4, said steps of determining the remote terminal and the risk of the undesirable effect within the wide field of view further comprising including a telephoto lens in an optical path for each instantaneous field of view of the plurality of instantaneous fields of view.

6. The method as recited in claim 5, said step of including the telephoto lens in the optical path further comprising including the telephoto lens to decrease a size of the instantaneous field of view of the first micromechanical mirror compared to a size of an unmodified instantaneous field of view of the first micromechanical mirror without the telephoto lens in the optical path.

7. The method as recited in claim 1, said step of reducing the risk of the undesirable effect being positioned within the narrow field of view further comprising reducing at least one of noise, interference, interception, jamming and spoofing on the optical link by the undesirable effect.

8. The method as recited in claim 1, further comprising the step of tracking motion of the remote terminal relative to the narrow field of view based on optical signals received from the remote terminal.

9. The method as recited in claim 8, said step of pointing the first micromechanical mirror further comprising pointing the first micromechanical mirror based on results from said step of tracking motion of the remote terminal.

10. The method as recited in claim 1, further comprising the step of tracking motion of the undesirable effect relative to the narrow field of view based on optical signals received from the undesirable effect.

11. The method as recited in claim 1, further comprising.
determining a second remote terminal within a second wide field of view associated with a second micromechanical mirror of a plurality of micromechanical mirrors in the local terminal which includes the first micromechanical mirror; and
pointing the second micromechanical mirror by including the second remote terminal within a second narrow field of view that is narrower than the second wide field of view.

12. The method as recited in claim 11, wherein the plurality of micromechanical mirrors comprises an array of evenly space micromechanical mirrors in an integrated unit.

13. The method as recited in claim 12, wherein the array of evenly spaced micromechanical mirrors is a one dimensional array.

14. The method as recited in claim 12, wherein the array of evenly spaced micromechanical mirrors is a two dimensional array.

15. The method as recited in claim 1, said step of determining the remote terminal further comprising distinguishing the remote terminal from the undesirable effect based on optical signals received from the remote terminal for authentication.

16. The method as recited in claim 11, said step of pointing the second micromechanical mirror further comprising pointing the second micromechanical mirror independently of the first micromechanical mirror.

17. The method as recited in claim 11, wherein the remote terminal recited in claim 1 is different from the second remote terminal.

18. The method as recited in claim 11, wherein the remote terminal recited in claim 1 is the same as the second remote terminal.

19. A local terminal for a free-space optical communications link with a remote terminal comprising:
a means for determining a remote terminal within a wide field of view associated with a micromechanical mirror in the local terminal;
a means for determining, within the wide field of view, a risk of an undesirable effect which imposes at least one of a performance cost and a security cost; and
a means for pointing the micromechanical mirror by
including the remote terminal within a narrow field of view that is narrower than the wide field of view, and
reducing the risk of the undesirable effect being positioned within the narrow field of view.

20. A local terminal for a free-space optical communications link with a remote terminal comprising:
an optical communication terminal comprising at least one of an optical communications transmitter and an optical communications receiver;
a micromechanical mirror;
an optical coupler for directing the optical communications terminal with the micromechanical mirror to produce a particular size field of view;
a controller for pointing the micromechanical mirror within a range of angles; and
one or more processors, operatively connected to the controller, for executing one or more sequences of instructions, wherein execution of the one or more sequences of instructions by the one or more processors causes the one or more processors to perform the steps of:
determining a remote terminal within a wide field of view based on the particular size field of view;
determining, within the wide field of view, a risk of an undesirable effect which imposes at least one of a performance cost and a security cost; and
sending an operating signal to the controller that causes the controller to point the micromechanical mirror to include the remote terminal within a narrow field of view based on the particular size field of view, wherein the narrow field of view is narrower than the wide field of view, and to reduce the risk of the undesirable effect being located in the narrow field of view.

21. The local terminal as recited in claim 20, further comprising a telephoto lens disposed in an optical path between the micromechanical mirror and the remote terminal to reduce the particular size field of view to the narrow field of view.

22. The local terminal as recited in claim 21, wherein:
the telephoto lens is disposed in a plurality of optical paths formed by the controller pointing the micromechanical mirror over a corresponding plurality of angles in the range of angles; and
the wide field of view is formed by pointing the micromechanical mirror over the corresponding plurality of angles.

23. The local terminal as recited in claim 20, wherein:
the local terminal further comprises a tracking array of optical detectors operatively connected to a second processor for tracking the remote terminal; and
said optical coupler further comprises a beam splitter for directing to the tracking array a portion of optical energy of optical signals received from the remote terminal over the optical communications optical link.

24. The local terminal as recited in claim 20, further comprising:
a plurality of optical communication terminals including the optical communication terminal;
a corresponding plurality of micromechanical mirrors including the micromechanical mirror on an integrated unit; and
a corresponding plurality of optical couplers including the optical coupler.

25. The local terminal as recited in claim 24, wherein the corresponding plurality of micromechanical mirrors is arranged in a regularly spaced one dimensional array on the integrated unit.

26. The local terminal as recited in claim 24, wherein the corresponding plurality of micromechanical mirrors is arranged in a regularly spaced two dimensional array on the integrated unit.

27. A computer-readable medium carrying one or more sequences of instructions for establishing a free-space optical communications link between a local terminal and a remote terminal, wherein execution of the one or more sequences of instructions by one or more processors causes the one or more processors to perform the steps of:
determining a first angular position of a remote terminal within a wide field of view associated with a micromechanical mirror in a local terminal for a free-space optical communications link;
determining, within the wide field of view, a risk of an undesirable effect which imposes at least one of a performance cost and a security cost; and
sending output data to a controller that causes the controller to point the micromechanical mirror to include the remote terminal within a narrow field of view that is narrower than the wide field of view, and to reduce the risk of including the undesirable effect within the narrow field of view.

28. The computer-readable medium as recited in claim 27, wherein:
execution of the one or more sequences of instructions further causes the one or more processors to perform the step of receiving, from an array of optical detectors, input data indicating angular positions of optical signals received within the wide field of view; and
at least one of said steps of determining the first angular position and determining the risk is performed based at least in part on the input data.

29. A local terminal for a free-space optical communications link with a remote terminal comprising:
an optical communication terminal comprising at least one of an optical communications transmitter and an optical communications receiver;
a micromechanical mirror;
a first optical coupler for directing the optical communications terminal with the micromechanical mirror to produce a particular size field of view in free space;
a controller for pointing the micromechanical mirror within a range of angles;
a photo-detector array comprising a plurality of photo-detectors;
a second optical coupler for directing at least part of a received optical beam to the photo-detector array; and
one or more processors, operatively connected to the controller and the photo-detector array, for executing one or more sequences of instructions, wherein execution of the one or more sequences of instructions by the one or more processors causes the one or more processors to perform the steps of:
tracking a remote optical source position in the field of view of the micromechanical mirror based on measurements obtained by the photo-detector array; and
sending an operating signal to the controller that causes the controller to point the micromechanical mirror based at least in part on the remote optical source position.
